(19) United States
(12) Patent Application Publication
(10) Pub. No.: US 2008/0252822 A1
(43) Pub. Date: Oct. 16, 2008

(54) Image Display Apparatus

(75) Inventors: Hendrik De Koning, Eindhoven (NL); Leendert Marinus Hage, Eindhoven (NL); Armanda Cinderella Nieuwkerk, Grashoek (NL); Dirk Jan Broer, Eindhoven (NL); Martin Jacobus Johan Jak, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/088,947

(22) PCT Filed: Oct. 2, 2006
(86) PCT No.: PCT/IB06/53579

§ 371 Date: Apr. 2, 2008

(30) Foreign Application Priority Data
Oct. 3, 2005 (EP) 05109149.4

(51) Int. Cl. G02F 1/1334

(52) U.S. Cl. 349/88

(57) ABSTRACT

An electro-optical switch, which can be switched between a substantially transparent state and a scattering state on basis of respective applied voltages, is disclosed. The electro-optical switch has a reflection-voltage curve that is steep enough to allow multiplexing. The electro-optical switch comprises: a scattering layer (302) comprising a liquid crystal-polymer composite; and a reflective layer (306) for reflecting a portion of scattered light back towards the scattering layer (302).

The invention relates to an electro-optical switch which can be switched between a substantially transparent state and a scattering state on basis of respective applied voltages, the electro-optical switch comprising a scattering layer.

The invention further relates to an image display apparatus, comprising:

such an electro-optical switch; and

sets of electrodes for switching respective portions of the electro-optical switch between the transparent state and the scattering state, by means of addressing the respective sets of electrodes.

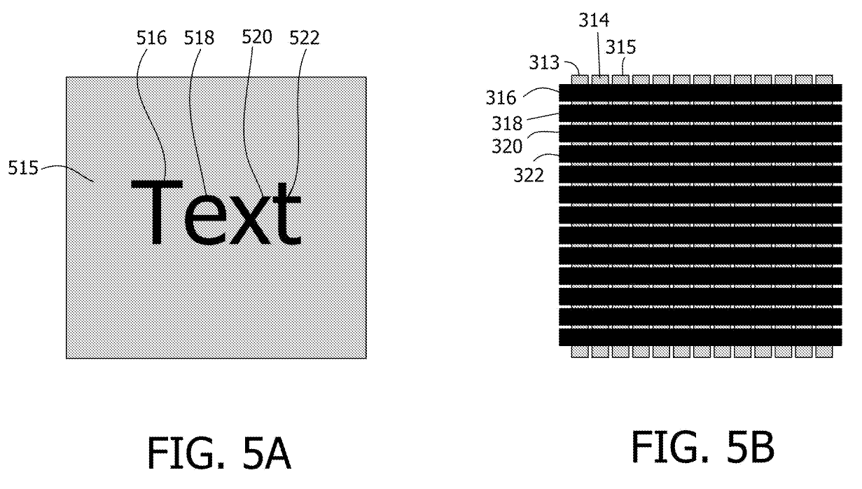

A scattering layer which is switchable (for a light beam) between a substantially transparent state and a scattering state, can be used for a variety of applications. For instance it may be applied for alternately hiding and showing an object which is located behind the scattering layer or for privacy protection. Advertisement and signage are other types of applications. Typically, the complete scattering layer is switched between the substantially transparent state and the scattering state. Alternatively, a predetermined optionally irregular shaped portion of the scattering layer corresponding to the also irregularly shaped electrodes at opposite sites of the scattering layer are switched between the substantially transparent state and the scattering state. In other words, the shape of the electrodes corresponds to the information to be displayed (See FIG. 5A). It will be clear that displaying other information requires adaptation of the shape of the electrodes.

Image display apparatus on basis of such a scattering layer having a passive matrix addressing scheme are rare. The reason is that the maximum number of rows, corresponding to adjacent strips of the scattering layer that can be electrically independently driven with a certain contrast, in a predetermined period of time, or even simultaneously, is very limited. That means that the multiplex rate is low. In passive matrix addressing the maximum number of rows (Nmax) that can be driven with a certain contrast is determined by Equation 1, according to Alt & Pleshko (See Alt, P. M., and P. Pleshko. 1974. IEEE Trans. Electron. Devices. ED-21: 146-155):

$${N}_{max} = \frac{{\{ {( {V}_{th} + Δ V )}^{2} + {V}_{th}^{2} \}}^{2}}{{\{ {( {V}_{th} + Δ V )}^{2} - {V}_{th}^{2} \}}^{2}} \qquad ( 1 )$$

with Vₜₕ being the threshold voltage above which the amount of reflection starts to change substantially and ΔV being the difference between Vₛₐₜ and Vₜₕ divided by two, with Vₛₐₜ being the voltage above which the reflection does not substantially change anymore.

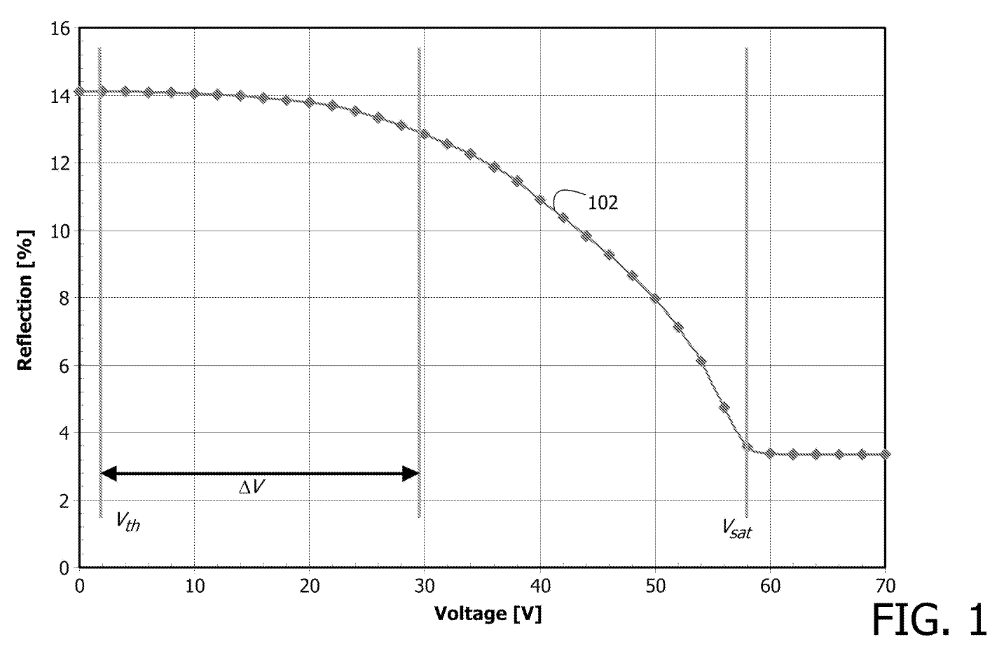

To determine the values of Vₜₕ and ΔV for a particular scattering layer, the reflection of diffuse illumination as function of applied voltage across the particular scattering layer has to be measured. FIG. 1 shows the measured reflection as function of voltage for a typical scattering layer. From FIG. 1 the following values can be determined: Vₜₕ=2V, ΔV=29V. With Equation 1 it can be computed that the maximum number of rows which can be driven with passive matrix addressing (Nmax, i.e. multiplex rate)=1 for this typical scattering layer. The scattering layer in this example is based on material that is commercially available from Chelix (an American company) and specified in e.g. United States patent U.S. Pat. No. 6,897,936. Multiple measurements were performed for alternative switchable scattering layers, resulting in similar reflection-voltage curves, i.e. representing the reflection as function of voltage.

It will be clear that given the electro-optical properties from off-the-shelf scattering layers, passive matrix addressing with a relatively high multiplexing rate is not possible without special measures.

It is an object of the invention to provide an electro-optical switch and an image display apparatus of the kind described in the opening paragraph, which have a relatively high multiplex ratio. A relatively high multiplex ratio means that at least eight portions of the electro-optical switch can be independently addressed by means of multiplexing.

This object of the invention is achieved in that the electro-optical switch comprises:

a scattering layer comprising a liquid crystal-polymer composite; and

a reflective layer for reflecting a portion of scattered light back towards the scattering layer.

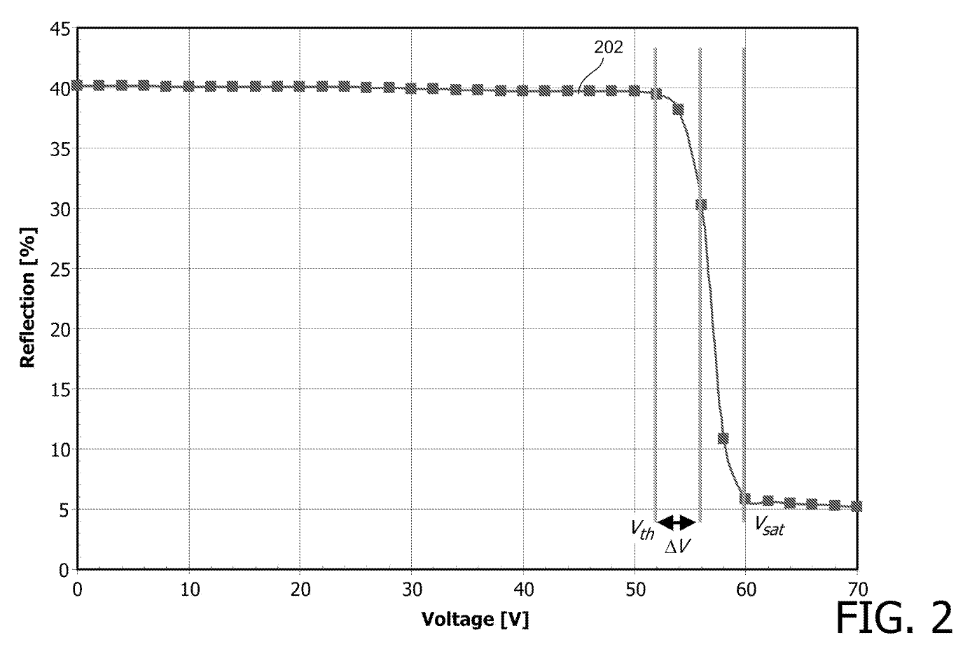

By adding a reflective layer to the switchable scattering layer the multiplex ratio is substantially increased. FIG. 2 shows the measured reflection as function of voltage, i.e. the reflection-voltage curve for the scattering layer of FIG. 1, to which a reflective layer is added. From FIG. 2 it can be determined that Vₜₕ=52V, ΔV=4V. With Equation 1 it can be computed that the maximum number of rows which can be driven with passive matrix addressing (Nmax)=183 for this combination of scattering layer and reflective layer.

The electro-optical switch can be switched between transparent and scattering by applying an electrical field, or visa versa be switched from scattering to transparent. The scattering profile of the electro-optical switch as given by the ratio between forwards and backwards scattering and the aerial distribution of the forward scattered light and their spatial distributions are such that in combination with the reflective layer the amount of backscattered light saturates over a limited voltage range.

With scattering is meant that light is directed in random directions. Scattering also comprises diffuse reflection. The effect of diffuse reflection is that a portion of the ambient light is directed in a backwards direction, i.e. in the direction of a viewer of the image display apparatus comprising the electro-optical switch according to the invention.

Preferably, the distance between the scattering layer and the reflective layer is as small as possible. The scattering layer and the reflective layer may be directly adjacent without any further layer in between the two layers. Alternatively, one of the electrodes for applying a voltage across the scattering layer for controlling the amount of scattering of light is disposed in between the two layers. Preferably, a reflective index matching fluid, i.e. glue is applied to realize the optical contact between the reflective layer and the scattering layer.

An additional advantage of the reflective layer is that the effective driving voltages can be decreased. The result is that the power consumption is also decreased.

To achieve a reflection-voltage curve that is steep enough to allow multiplexing, the polymer content in the polymer-liquid crystal composite is of influence. The polymer content thereto is preferably chosen between 0.5 and 10 wt %, but preferably between 1 and 6 wt % and more preferably between 2 and 4 wt %.

Typically, the concentration of polymers relative to the liquid crystals in commercially available scattering layers is much higher. In particular, in switchable scattering layers the concentration of polymers relative to the liquid crystals is typically 20%. The reason for that is that the mechanical properties of the polymer network are relevant. Frequently switching between the different optical states of the scattering layer having a relatively low concentration of polymers relative to the liquid crystals may result in destruction of the polymer network.

That means that the selection of the particular concentration of the polymer network in the scattering layer is determined by:

the mechanical aspects, because the polymer network should be relatively durable and stable; and

the electro-optical aspects, because the multiplex ratio of the display device should be relatively high.

The liquid crystal can be nematic or chiral nematic by adding a chiral dopant to the nematic liquid crystal.

Preferably, the polymer is obtained by polymerization of a monomer previously added to the liquid crystal. In a preferred embodiment the monomer is polymerized and/or cross-linked by (UV) light. In an even more preferred embodiment the polymerization and/or cross-linking takes place while the liquid crystal is aligned. An external field, applied during polymerization, can achieve the alignment of the liquid crystal. Alternatively alignment of the liquid crystals is induced by an alignment inducing surface such as a rubbed polyimide, a surfactant, a surfactant containing polyimide or SiO2 evaporated at an oblique angle.

The presence of the reflective layer is essential. The reflective layer can be evaporated aluminum, silver or a dielectric stack. Alternatively the reflective layer is a semi transparent mirror.

In an embodiment of the electro-optical switch according to the invention, the reflective layer is a polarizer. The reflective polarizer can be a stack of alternating birefringent and non-birefringent layers in a periodicity that enables Bragg reflection for a first polarization direction and provides transmission for the orthogonal, i.e. second polarization direction. An example of a reflective polarizer that is based on this principle is a polarizer film supplied by 3M company under the name of Vikuity™ Dual Brightness Enhancement Films (DBEF).

Another way of making reflective polarizers is based on cholesteric films as described in U.S. Pat. No. 5,506,704, U.S. Pat. No. 5,793,456, U.S. Pat. No. 5,948,831, U.S. Pat. No. 6,193,937 and in ‘Wide-band reflective polarizers from cholesteric polymer networks with a pitch gradient’, D. J Broer, J. Lub, G. N. Mol, Nature 378 (6556), 467-9 (1995). In combination with a quarter wave film this film provides the same optical function as DBEF.

Alternatively, the reflective polarizer is based on the so-called wire grid principle where narrow periodic lines of a metal with a periodicity smaller than the wavelength of light are applied on a glass or plastic substrate.

Alternatively, the reflective layer is a scattering polarizer, which is arranged to reflect the portion of the scattered light beam having a particular polarization direction. A scattering polarizer is a material, which has different behavior for respective polarization directions. The scattering polarizer is substantially transparent for light having a first polarization direction and is arranged to scatter light having a second polarization direction, which is orthogonal with the first polarization direction. An example of the scattering polarizer is described in the PhD thesis of Henri Jagt, “Polymeric polarization optics for energy efficient liquid crystal display illumination”, 2001, Chapter 2 and in patent application WO01/90637.

This scattering polarizer can be based on particles embedded in a polymer matrix. Blending small particles with a known polymer like e.g. PEN or PET followed by extrusion of this mixture to a foil and stretching this foil, makes the scattering polarizer. The stretching provides uniaxial orientation, making it transparent for the first polarization direction whereas it is scattering for the orthogonal polarization direction.

In an embodiment of the electro-optical switch according to the invention, the scattering layer comprises a dye with a predetermined color. Preferably a dichroic dye is added to the liquid crystal material of the scattering layer. The dye color is enhanced in the scattering state and substantially hidden to a large extent in the non-scattering state. Alternatively colored polarizer filters are used to change the appearance of the electro-optical switch in a subtle way. That means that aesthetic properties of the electro-optical switch are modified.

Preferably the electrodes comprise indium tin oxide (ITO) but can occasionally also be indium zinc oxide (IZO) or organic conducting material also known to those skilled in the field as a transparent electrode.

The image display apparatus according to the invention may be a reflective display apparatus, whereby the light corresponds to ambient light. The scattering layer is arranged to scatter a portion of the ambient light which falls on the scattering layer. With ambient light is meant, light that originates from any light source, which does not belong to the display apparatus. The light source may be a lamp in the room in which the display apparatus is located. Ambient light may also be sunlight coming through the windows of the room in which the display apparatus is located.

Alternatively, the image display apparatus according to the invention is a transflective display apparatus. This embodiment of the image display apparatus according to the invention further comprises a backlight for generating light. The scattering layer is arranged to scatter a portion of the light which is generated by the backlight and which falls on the scattering layer. The reflective layer may comprise holes for the transmission of the light beam, which is generated by the backlight.

These and other aspects of the electro-optical switch and of the image display apparatus, according to the invention will become apparent from and will be elucidated with respect to the implementations and embodiments described hereinafter and with reference to the accompanying drawings, wherein:

FIG. 1 shows the measured reflection as function of voltage for a typical scattering layer without a reflective layer attached to it;

FIG. 2 shows the measured reflection as function of voltage for the scattering layer of FIG. 1 with a reflective layer attached to it;

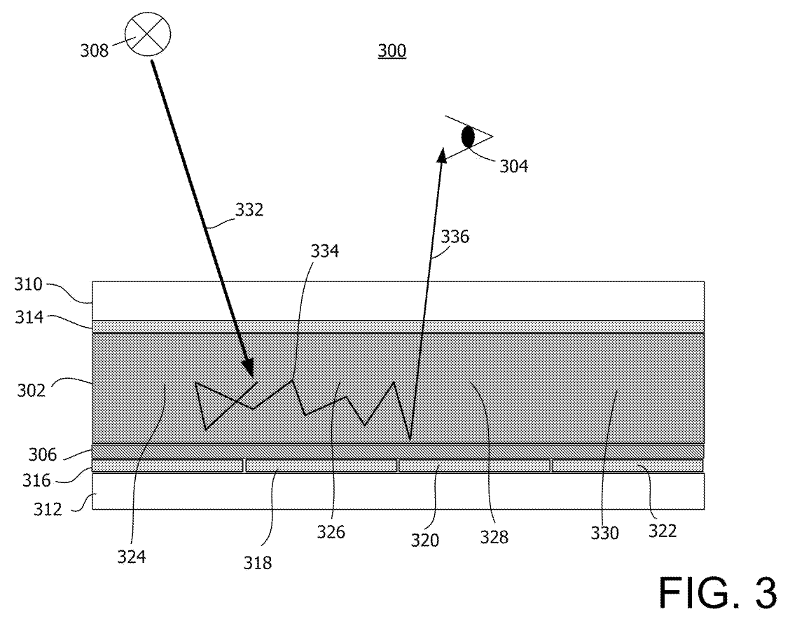

FIG. 3 schematically shows a reflective image display apparatus according to the invention;

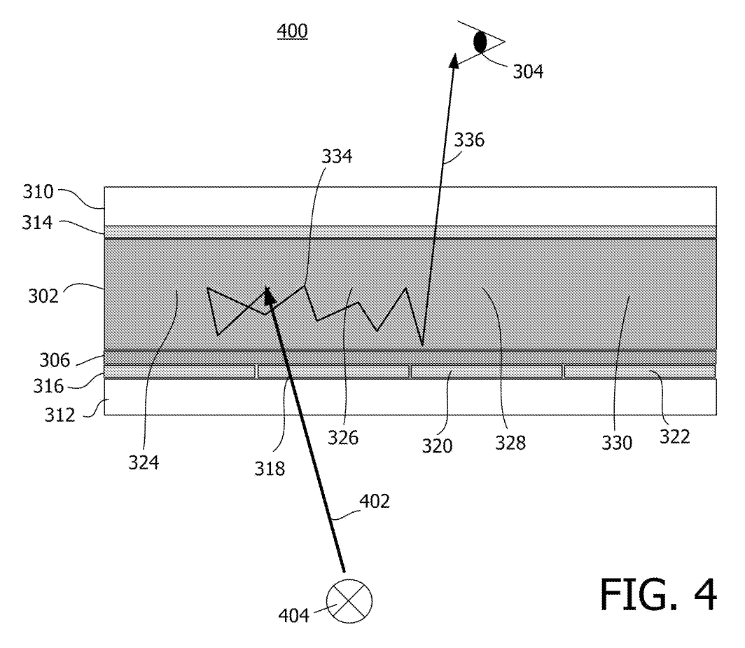

FIG. 4 schematically shows a transflective image display apparatus according to the invention;

FIG. 5A schematically shows a configuration of electrodes, whereby the electrodes have mutually different shapes;

FIG. 5B schematically shows an alternative configuration of electrodes, whereby the electrodes are strips of conductive material;

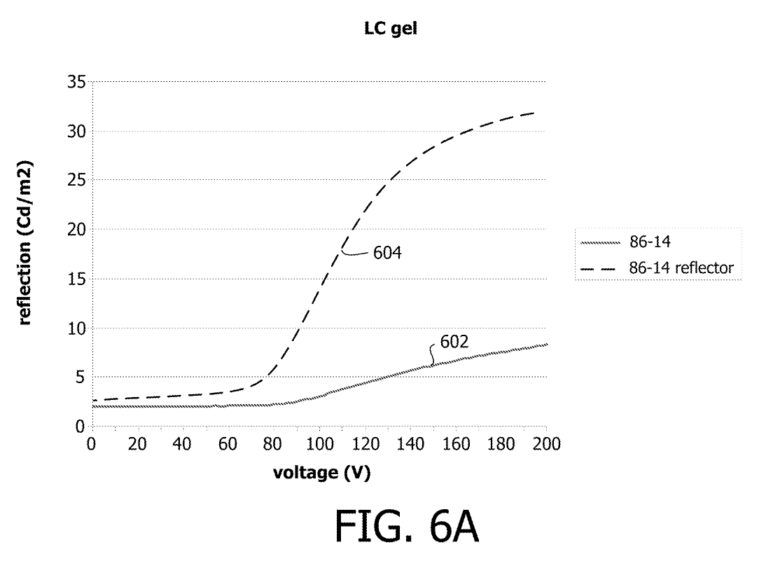

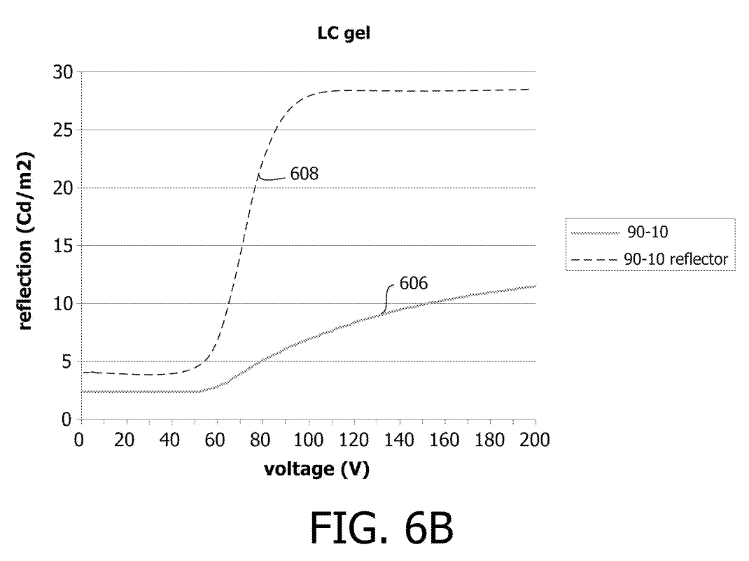

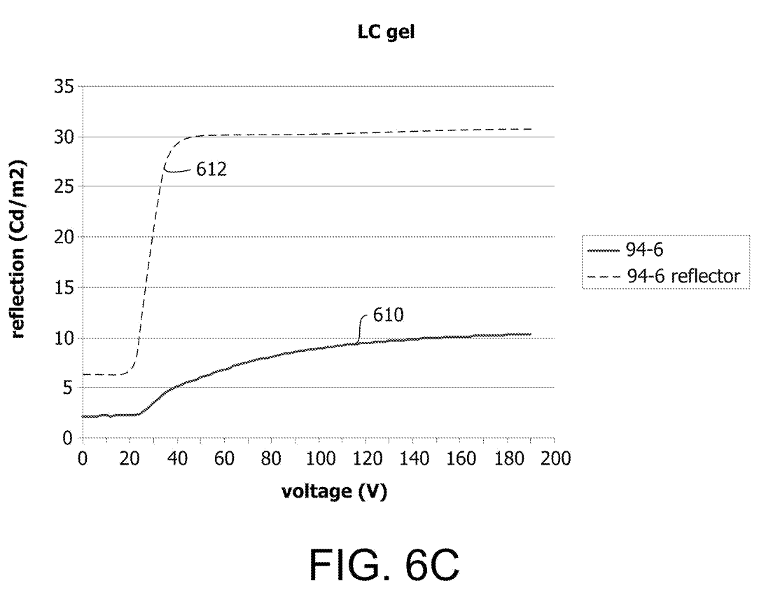

FIG. 6A shows the measured reflection as function of voltage for a scattering layer with and without a reflective layer attached to it, whereby the concentration of polymer is 14%;

FIG. 6B shows the measured reflection as function of voltage for a scattering layer with and without a reflective layer attached to it, whereby the concentration of polymer is 10%;

FIG. 6C shows the measured reflection as function of voltage for a scattering layer with and without a reflective layer attached to it, whereby the concentration of polymer is 6%;

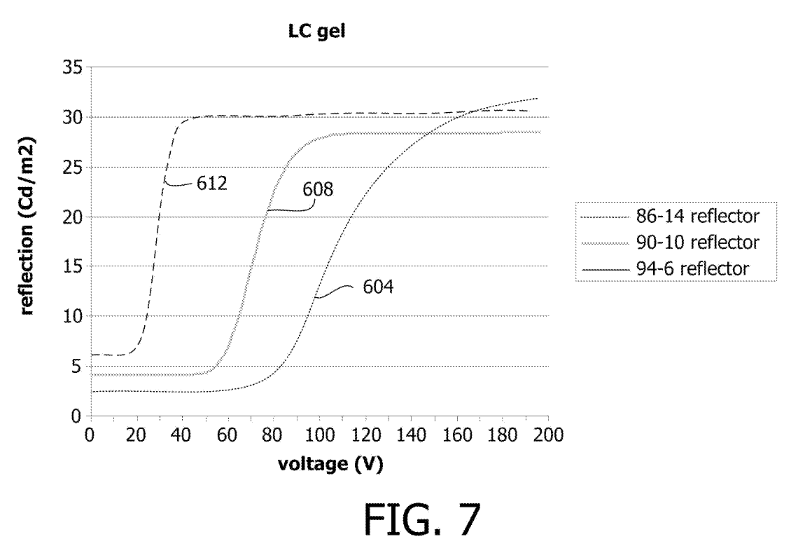

FIG. 7 shows the measured reflection as function of voltage for the scattering layers of FIGS. 6A-6C, all with a reflective layer attached to it;

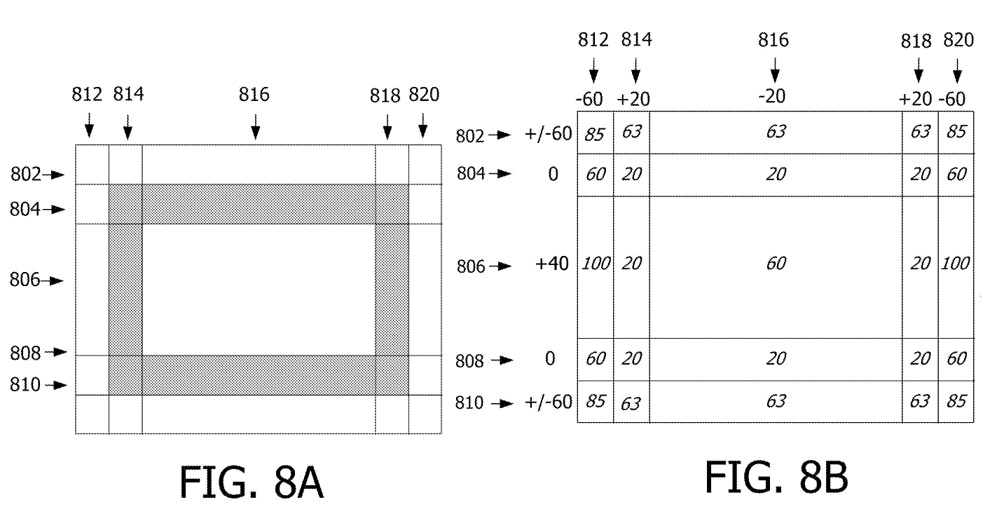

FIG. 8A schematically shows a desired pattern to be generated;

FIG. 8B schematically shows the voltages which could be applied to the electrodes to generate the desired pattern as depicted in FIG. 8A;

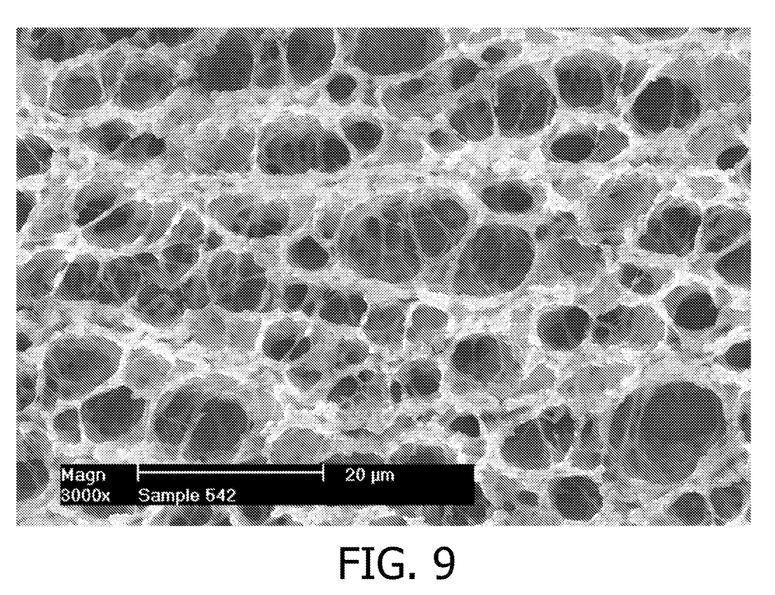

FIG. 9 shows an image of a scattering layer, acquired by a microscope;

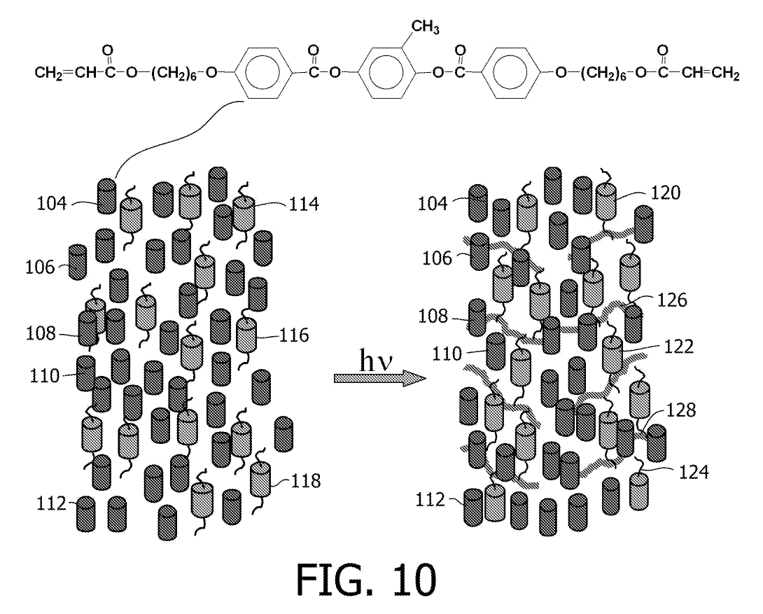

FIG. 10 schematically shows an example of the process of making a scattering layer based on a liquid crystal polymer composite;

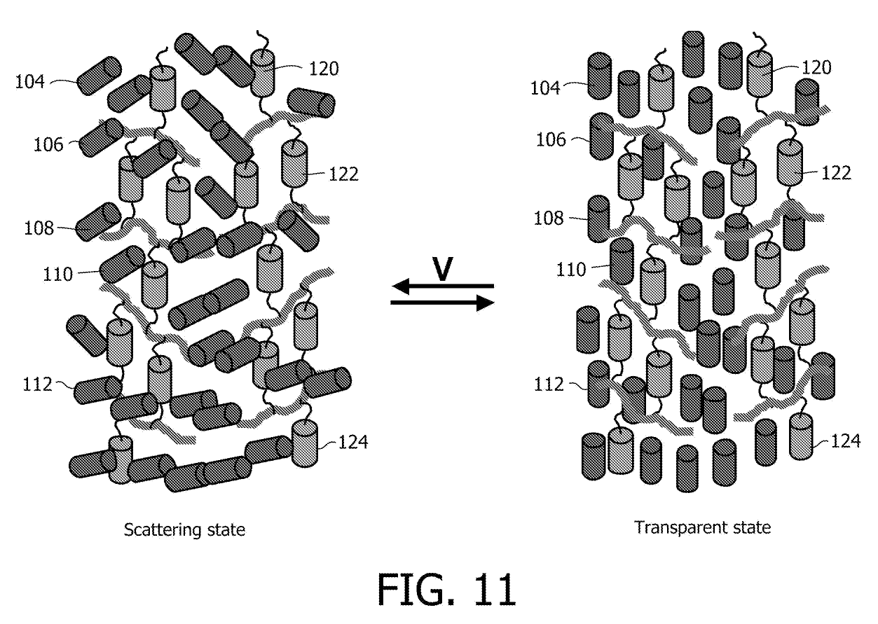

FIG. 11 schematically shows an example of the scattering state and the transparent state of a scattering layer based on a liquid crystal polymer composite; and

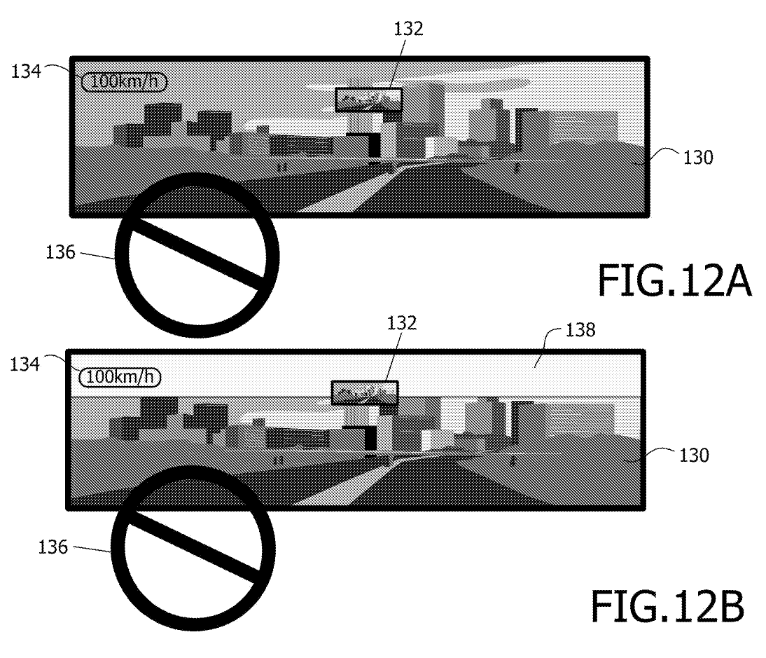

FIG. 12A and FIG. 12B schematically show the application of an embodiment of the image display apparatus according to the invention in a vehicle.

Same reference numerals are used to denote similar parts throughout the Figures.

Modifications of the electro-optical switch and variations thereof may correspond to modifications and variations thereof of the image display apparatus, being described.

FIG. 1 shows the measured reflection as function of voltage for a typical scattering layer without a reflective layer attached to it. During the measurement, the scattering layer was placed in a closed box, which prevented ambient light to enter. In the box a light source was placed to illuminate the scattering layer with diffuse white light and a light detector for detecting the amount of reflected light being reflected by the scattering layer. At opposite sides of the scattering layer substantially transparent electrodes were placed by means of which a range of voltages were applied to the scattering layer, while the amount of generated white light was kept constant. A number of samples were acquired, i.e. the amount of reflected light for different voltages was measured. The y-axis of FIG. 1 corresponds to the computed amount of reflected light, i.e. the ratio between the amount of generated and reflected light. The x-axis of FIG. 1 corresponds to the applied voltage.

The reflection-voltage curve of FIG. 1 shows that the amount of reflection gradually decreases from approximately 14% to approximately 3% when the applied voltage increases from 3 volt to 60 volt. The difference between the maximum amount of reflection and minimum amount of reflection is relatively small, i.e. approximately 11%. However, the fact that the amount of reflection changes gradually over a relatively large range of voltages, instead of with a steep step is a more serious issue. It makes the particular scattering layer hardly or even not suitable for application in an image display apparatus, whereby light modulation is based on passive matrix addressing, unless the scattering layer is combined with a reflective layer, according to the invention.

FIG. 2 shows the measured reflection as function of voltage for the scattering layer of FIG. 1 with a reflective layer adjacent to it. The reflection-voltage curve of FIG. 2 shows that the amount of reflection is substantially constant for the large range of voltages from 0 volt to 52 volt. Then the amount of reflection drops significantly over a relatively small range of voltages. The difference between the maximum amount of reflection and minimum amount of reflection is relatively large, i.e. approximately 35%. Both aspects, i.e. the fact that the amount of reflection changes relatively much over a relatively small range of voltages and the fact that the difference between the maximum amount of reflection and minimum amount of reflection is relatively large makes the combination of the particular scattering layer and the reflective layer suitable for application in an image display apparatus, whereby light modulation is based on passive matrix addressing.

FIG. 3 schematically shows a reflective image display apparatus 300 according to the invention. The image display apparatus 300 comprises:

a scattering layer 302 comprising liquid crystals, which is switchable between a substantially transparent state and a scattering state, for a light beam 332;

sets of electrodes 314-322 for switching respective portions 324-330 of the scattering layer 302 between the transparent state and the scattering state, by means of passive matrix addressing of the respective sets of electrodes;

a reflective layer 306 for reflecting a portion 336 of the scattered light beam 334 back towards the scattering layer 302;

a set of cover plates 310-312. At least one of the cover plates 310 is transparent. Preferably at least one of the cover plates 310 is made of glass; and

driving means for providing appropriate voltages to the sets of electrodes 314-322.

The reflective image display apparatus 300 is arranged to generate images by means of modulation of ambient light 332, which falls on the scattering layer 302. By modulation of the voltages across the different independently controllable portions 324-330 of the scattering layer 302 corresponding patterns of more or less scattering, i.e. diffuse reflection, are created. These patterns cause a modulation of the reflected portion of the ambient light 332, which is generated by the ambient light source 308. Typically the ambient light source 308 does not belong to the reflective image display apparatus 300.

Preferably the electrodes comprise indium tin oxide (ITO) but can occasionally also be indium zinc oxide (IZO) or organic conducting material also known to those skilled in the field as a transparent electrode.

Preferably, the electrodes 314-322 are structured as two groups of strips of transparent conductive material, which are disposed at opposite sides of the scattering layer. See FIG. 5B. Preferably, the electrodes 314 of the first group are oriented substantially orthogonal to the electrodes 316-322 of the second group. The electrodes 314 of the first group of electrodes extend over respective columns of the scattering layer 302, while the electrodes 316-322 of the second group of electrodes extend over respective rows of the scattering layer 302. By appropriately applying voltages between pairs of electrodes, each pair comprising a selected electrode 314 of the first group of electrodes and a selected electrode 316 of the second group of electrodes, different portions 324-330 of the scattering layer 302 can be addressed, i.e. the local amount of scattering can be modulated. This type of modulation is known as passive matrix addressing to the person skilled in the art of image display driving.

In FIG. 3 a typical path of a light beam is depicted. The light beam, which is generated by the ambient light source 308, enters the scattering layer 302. The light beam is scattered in the scattering layer 302, whereby the amount of scattering depends on the local potential difference between the electrodes 314-320 at opposite sides of the scattering layer. A portion of the scattered light beam 334 is reflected by the reflective layer 306 and after additional scattering, light beam 336 is directed to a viewer 304.

The scattering layer 302 comprises liquid crystals, which are stabilized by a polymer network, whereby the concentration of the polymer network is approximately 2%. In e.g. United States patent U.S. Pat. No. 6,897,936 is disclosed how such a scattering layer can be made.

FIG. 4 schematically shows a transflective image display apparatus 400 according to the invention. Most of the components of the transflective image display apparatus 400 are equal to the components of the reflective image display apparatus 300 as described in connection with FIG. 3. The following differences are relevant:

The transflective image display apparatus 400 comprises its own light source 404. Besides ambient light which may fall on the scattering layer 302 also light being generated by the transflective image apparatus itself is scattered, light beam 334 and eventually directed towards a viewer 304, light beam 336;

Both of the cover plates 310-312 are transparent. Alternatively, the cover plate 312 having the shortest distance relative to the light source 404 comprises a structure of holes for transmission of light being generated by the light source 404.

The reflective layer 306 comprises means for transmission of the light being generated by the light source 404. Preferably these means are a structure of holes.

FIG. 5A schematically shows a configuration of electrodes 515-522, whereby the electrodes 515-522 have mutually different shapes. In FIG. 5A two groups of electrodes are depicted. The first group of electrodes 515 is located at a first side of the scattering layer 302 (not depicted). The second group of electrodes 516-522 is disposed at the second, i.e. the opposite side of the scattering layer 302. The shapes of the electrodes 515-522 are mutually different. The different electrodes 516-522 of the second group of electrodes have shapes, which correspond to respective characters. For instance a first one 516 of the electrodes of the second group has a shape which corresponds to the character “T”, a second one 518 of the electrodes of the second group has a shape which corresponds to the character “e”, a third one 520 of the electrodes of the second group has a shape which corresponds to the character “x” and the fourth one 522 of the electrodes of the second group has a shape which corresponds to the character “t”.

The electrodes 515 the first group of electrodes may have shapes which correspond to the shapes the second group of electrodes. Alignment between the electrodes of the pairs of electrodes is important. Alternatively, the first group of electrodes has only a single element, i.e. there is only one electrode at the first side of the scattering layer 302.

It will be clear that the number of different images which can be displayed by means of a display apparatus having an electrode configuration as described above in connection with FIG. 5A is limited. Only images consisting of permutations of the four characters at the predetermined positions can be displayed.

FIG. 5B schematically shows an alternative configuration of electrodes, whereby the electrodes are strips of conductive material. The first group of electrodes 313-315 is located at a first side of the scattering layer 302 (not depicted). The second group of electrodes 316-322 is disposed at the second, i.e. the opposite side of the scattering layer 302. By means of the two groups of electrodes and on basis of passive matrix addressing a variety of patterns can be generated, i.e. many different images can be displayed.

FIG. 6A shows the measured reflection as function of voltage for a scattering layer 302 based on liquid crystal gel, with 604 and without 602 a reflective layer 306 attached to the scattering layer 302. The amount of reflection for potential differences above 60 volt, is substantially higher for the combination of scattering layer 302 and reflective layer 306 than for the single scattering layer 302. The scattering layer 302 is a polymer LC gel made by Philips Research, whereby the concentration of polymer is 14%. A reflective polarizer is used as reflective layer 306.

FIG. 6B shows the measured reflection as function of voltage for a scattering layer 302 based on liquid crystal gel, with 608 and without 606 a reflective layer 306 attached to the scattering layer 302. The amount of reflection for potential differences above 46 volt, is substantially higher for the combination of scattering layer 302 and reflective layer 306 than for the single scattering layer 302. The scattering layer 302 is a polymer LC gel made by Philips Research, whereby the concentration of polymer is 10%. A reflective polarizer is used as reflective layer 306.

FIG. 6C shows the measured reflection as function of voltage for a scattering layer 302 based on liquid crystal gel, with 604 and without 602 a reflective layer 306 attached to the scattering layer 302. The amount of reflection for potential differences above 16 volt, is substantially higher for the combination of scattering layer 302 and reflective layer 306 than for the single scattering layer 302. The scattering layer 302 is a polymer LC gel made by Philips Research, whereby the concentration of polymer is 6%. A reflective polarizer is used as reflective layer 306.

FIG. 7 shows the measured reflection as function of voltage 604, 608 and 612 for the scattering layers of FIGS. 6A-6C all with a reflective layer attached to the respective scattered layers.

Table 1 below provides a number of parameters that are derived from the reflection-voltage curves of FIGS. 6A-6C.

TABLE 1

| Polymer | | | | | |
|---|---|---|---|---|---|
| concen- | Cell | Scat- | | | Multi- |
| tration | gap | tering | | | plex |
| (%) | (μm) | layer | Vₜₕ [V] | ΔV [V] | rate |
| 6 | 18 | yes | 16 | 7 | 8.2 |
| 10 | 18 | yes | 46 | 43 | 2.9 |
| 14 | 18 | yes | 60 | 95 | 1.8 |
| 14 | 6 | yes | 26 | 66 | 1.3 |
| 6 | 18 | No | 22 | 100 | 1.1 |

From Table 1 can easily be derived that:

the multiplex ratio of a scattering layer can be significantly increased by the usage of a reflective layer;

the multiplex ratio of a scattering layer combined with a reflective layer is inversely proportional to the polymer concentration. The lower the concentration, the higher the multiplex ratio;

the driving voltage of a scattering layer combined with a reflective layer is inversely proportional to the polymer concentration. The lower the concentration, the lower the driving voltages, i.e. [Vₜₕ, ΔV].

the thickness of the scattering layer (Cell gap) also influences the multiplex ratio. If the thickness of the scattered layer increases, also the multiplex ratio increases. However the effect of the thickness of the scattered layer on the multiplex ratio is less strong than the effect of the concentration of polymer.

Table 2 below lists the multiplex ratios that are derived from the reflection-voltage curves of FIGS. 1 and 2.

TABLE 2

| Polymer network cholesteric LC = Chelix mixture. | |
|---|---|
| 2-3% without reflective polarizer | 1.0 |
| 2-3% with reflective polarizer | 183.0 |

FIG. 8A schematically shows a desired pattern to be generated by an embodiment of the image display apparatus according to the invention. The pattern is a “scattering” border in a further transparent area. Five rows 802-810 and five columns 812-820 can describe the pattern. At least three rows and three columns should be driven individually. And because of the symmetry of the pattern some of the rows/columns can be driven in parallel: the last two rows/columns are identical to the first two, and hence they can be driven in parallel.

FIG. 8B schematically shows the voltages which could be applied to the electrodes to generate the desired pattern as depicted in FIG. 8A. To the first column electrode, which corresponds to the first column 812 a voltage of −60 volt is applied, to the second column electrode, which corresponds to the second column 814 a voltage of 20 volt is applied, to the third column electrode, which corresponds to the third column 816 a voltage of −20 volt is applied, to the fourth column electrode, which corresponds to the fourth column 818 a voltage of 20 volt is applied and to the fifth column electrode, which corresponds to the fifth column 820 a voltage of −60 volt is applied. To the first row electrode, which corresponds to the first row 802 a voltage of +/−60 volt is applied, to the second row electrode, which corresponds to the second row 804 a voltage of 0 volt is applied, to the third row electrode, which corresponds to the third row 806 a voltage of 40 volt is applied, to the fourth row electrode, which corresponds to the fourth row 808 a voltage of 0 volt is applied and to the fifth row electrode, which corresponds to the fifth row 810 a voltage of +/−60 volt is applied. All voltages need to be inverted at a frequency high enough to avoid flicker, in order to avoid charge build-up. The optical effect of the scattering material is determined by the root mean square voltage (Vᵣₘₛ). The actual root mean square voltage for each of the portions of the scattering layer 302 is depicted with italics.

Preferably, one of the row or column signals is inverted at half (or double) the frequency of the other signals.

In the described driving scheme three different voltage levels are used for the three row signals, and three voltage levels are used for the three column signals, as opposed to the common 2 level (on/off) driving. There is no “line at a time” scanning of the image display apparatus, as is used in standard passive matrix addressing. In order to obtain uniform scattering and transparent regions according to the desired pattern preferably a reset pulse is inserted in the driving scheme. The reset pulse preferably is applied to the whole scattering layer 302.

FIG. 9 shows a scanning electron microscope picture of a liquid crystal polymer composite containing 6% of polymer.

FIG. 10 schematically shows the process of making a scattering layer 302 based on a liquid crystal polymer composite. The scattering layer 302 is made by adding a predetermined amount of monomer 114-118 to a predetermined amount of liquid crystals 104-112. By means of an electric field the molecules are directed in a required direction. Subsequently the composite is illuminated by ultraviolet light (hv) during a predetermined period of time. Under the influence of the ultraviolet light the monomer molecules 120-124 will be linked 126-128 to a polymer network. Alternatively, a relatively high temperature during a predetermined period of time is used for the cross-linking.

FIG. 11 schematically shows the scattering state and the transparent state of a scattering layer 302 based on a liquid crystal polymer composite. In the transparent state the liquid crystals are aligned with the molecules of the polymer network, i.e. the molecules are oriented in the same direction. In the transparent state the liquid crystals are not aligned with the molecules of polymer network. That means that the orientations of the molecules of the polymer network and the liquid crystals are mutually different. Typically, the orientations of the liquid crystals are random.

FIG. 12A and FIG. 12B schematically show the application of an embodiment of the image display apparatus according to the invention in a vehicle. FIG. 12A and FIG. 12B show the inside of a car, with one or optional multiple image display apparatus according to the invention being integrated in the front window of the car. FIG. 12A and FIG. 12B show the view 130 on the road in front of the car and the steering wheel 136.

FIG. 12A schematically shows two types of functionality which can be provided by an image display apparatus according to the invention. The actual speed is displayed by means of a numerical display 134. It will be clear that other type of status information can be provided to the user in a similar way.

Another portion 132 of the front window of the car serves as a display device to display a view to the driver of the car, which corresponds to images being captured by a camera, which is located such that the scene behind the car can be displayed. That means that the rear-view mirror is replaced by a combination of a camera and display device. Preferably the resolution of the display 132 is relatively high. That means that the multiplex ratio must be relatively high too. For this type of application a display matrix size of 200*200 pixels is required. As indicated above, a multiplex ratio with that order of magnitude is possible with a display apparatus according to the invention.

FIG. 12A schematically shows a portion 138 of the front window is put in a scattering state to block a portion of the sunlight. It will be clear that the size, shape and position of the portion of the front window can be adjusted on basis of the actual position of the eyes of the driver and the position of the sun relative to the front window.

Other types of applications are advertisement and/or signage. The size of the image display apparatus may vary over a relatively large range of dimensions, e.g. from a couple of centimeters to several meters. Because of the relatively easy construction of the image display apparatus according to the invention it can be manufactured relatively easy and hence relatively inexpensive.

A further type of application is realized by a combination of the image display apparatus according to the invention and a standard image display apparatus. By placing the image display apparatus according to the invention in front of a monitor or television it is possible to hide the screen of the monitor or television when the monitor or television is turned off. In the active state of the monitor or television, i.e. when it is turned on the image display apparatus according to the invention is put in its transparent state. Optionally, portions of the monitor and or television are covered/not covered. That may be useful if only a corresponding portion of the monitor or television is actually used. For instance if a 4:3 broadcast is displayed on a 16:9 screen or vice versa.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware or software. The usage of the words first, second and third, etcetera do not indicate any ordering. These words are to be interpreted as names.

1. An electro-optical switch which can be switched between a substantially transparent state and a scattering state on basis of respective applied voltages, the electro-optical switch having a reflection-voltage curve that is steep enough to allow multiplexing, the electro-optical switch comprising:
a scattering layer (302) comprising a liquid crystal-polymer composite; and
a reflective layer (306) for reflecting a portion of scattered light back towards the scattering layer (302).

2. An electro-optical switch as claimed in claim 1, whereby the polymer content in the polymer-liquid crystal composite is relatively low.

3. An electro-optical switch as claimed in claim 2, whereby the polymer content in the polymer-liquid crystal composite is in the range of 0.5% and 10%.

4. An electro-optical switch as claimed in claim 3, whereby the polymer content in the polymer-liquid crystal composite is in the range of 1% and 6%.

5. An electro-optical switch as claimed in claim 4, whereby the polymer content in the polymer-liquid crystal composite is in the range of 2% and 4%.

6. An electro-optical switch as claimed in claim 1, whereby the liquid crystals are nematic.

7. An electro-optical switch as claimed in claim 1, whereby the liquid crystals are chiral nematic.

8. An electro-optical switch as claimed in claim 1, whereby the polymer is obtained by polymerization of a monomer previously added to the liquid crystals.

9. An electro-optical switch as claimed in claim 8, whereby the monomer is polymerized and/or cross-linked by means of light, preferably UV light.

10. An electro-optical switch as claimed in claim 8, whereby the monomer is polymerized and/or cross-linked by means of temperature.

11. An electro-optical switch as claimed in claim 9, whereby the monomer is polymerized and/or cross-linked while the liquid crystals were aligned.

12. An electro-optical switch as claimed in claim 1, whereby the reflective layer (306) is made by means of evaporation of aluminum or silver.

13. An electro-optical switch as claimed in claim 1, whereby the reflective layer (306) is a dielectric stack.

14. An electro-optical switch as claimed in claim 13, whereby the reflective layer (306) is a stack of polymer layers with alternating refractive index.

15. An electro-optical switch as claimed in claim 13, whereby the reflective layer (306) is a stack of alternating substantially isotropic polymer and birefringent polymer.

16. An image display apparatus as claimed in claim 1, wherein the scattering layer (302) comprises a dye with a predetermined color.

17. An image display apparatus, comprising
An electro-optical switch as claimed in claim 1; and
sets of electrodes for switching respective portions of the scattering layer (302) between the transparent state and the scattering state, by means of addressing the respective sets of electrodes.

18. An image display apparatus (400) as claimed in claim 17, being a transflective display apparatus further comprising a backlight for generating light to be modulated by the electro-optical switch.

19. An image display apparatus (300) as claimed in claim 17, being a reflective display apparatus.

20. An image display apparatus as claimed in claim 17, wherein a reset pulse between the various states is applied in order to obtain uniformly scattering patterns.
